(19) United States
(12) Patent Application Publication
(10) Pub. No.: US 2019/0288511 A1
(43) Pub. Date: Sep. 19, 2019

(54) STORAGE UNIT FOR A LOAD, AND STORAGE SYSTEM

(71) Applicant: Tobias Mader, Schwabsoien (DE)

(72) Inventor: Tobias Mader, Schwabsoien (DE)

(21) Appl. No.: 16/345,133

(22) PCT Filed: Oct. 27, 2017
(86) PCT No.: PCT/EP2017/077637

§ 371 Date: Apr. 25, 2019

(30) Foreign Application Priority Data
Oct. 27, 2016 (DE) 10 2016 120 575.3

(51) Int. Cl. H02J 3/32

(52) U.S. Cl. CPC H02J 3/32

(57) ABSTRACT

A storage unit for a consumer is described, comprising an energy storage in which electrical energy can be stored. The storage unit has a current interface via which the storage unit can be connected to an electrical grid. Furthermore, the storage unit comprises a circuitry positioned between the energy storage and the current interface in the direction of current flow, and a server unit which is configured to set up a decentralized computing network along with further server units, by means of which transactions are managed, controlled and/or monitored in a decentralized manner. A storage system is furthermore described.

The invention relates to a storage unit for a consumer and to a storage system.

In recent years, the ecological awareness of people has increased, which is why more and more energy is provided by renewable energy sources to meet the growing energy demand of the people and to reduce the share of fossil energy sources. Renewable energy sources can be wind power or solar energy, for example. Accordingly, wind turbines or solar modules are used to generate energy in wind or sunshine, respectively.

As the energy needs are independent of the weather conditions, it must be possible to temporarily store the energy generated from renewable energy sources and to retrieve it as needed.

Concerning this, the prior art discloses, among others, a central storage power plant to generate high capacities and temporarily store energy. If the renewable energy sources generate more energy than needed, the excess energy can be used to pump water to a higher potential energy level. As soon as the energy demand increases and is no longer covered by the currently generated energy, the pumped-up water can be drained to generate electrical energy via turbines. With pumped-storage power plants, fluctuations in the supply grid can thus be balanced out or overcapacities reduced.

The fact that pumped-storage power plants need a lot of space and the construction and the maintenance are expensive proved to be disadvantageous.

Furthermore, decentralized storage units are known which are operated along with a decentralized photovoltaic system to temporarily store energy generated at a consumer or a user, a typical family household, for example, by means of the photovoltaic system. The energy temporarily stored in the storage unit can be consumed by the consumer itself and/or fed into a supply grid to which several households are connected and from which the households draw their energy.

The consumer therefore accesses the temporarily stored energy itself in order to determine what proportion is fed into the supply grid or it consumes itself.

The supply grid is usually operated, i.e. managed, checked and monitored in a centralized manner by an energy supplier or a grid operator. Therefore, the energy supplier or grid operator has to stabilize the supply grid such that possibly occurring load fluctuations, for example, can be supported. This poses great difficulties for the energy supplier or the grid operator, especially because of the renewable energies.

Therefore, a central management of the supply grid is known from the prior art, a centrally managed energy storage (pumped-storage power station) or a plurality of decentralized storage units being used, which are usually operated locally on site by the respective consumer or user. However, in the decentralized storage units, the central energy supplier or grid operator has no access possibility to the temporarily stored amounts of energy. The grid operator or energy supplier can at best retrieve consumption and/or feed data of the appropriate storage unit which are required for the billing of the amounts of energy.

Furthermore, the expenditure with respect to the billing of the amounts of energy is high, as this must also be carried out centrally by the energy supplier or the access possibility.

The object of the invention is to ensure a permanent and reliable energy supply of the individual consumers or users in a cost-effective and simple manner.

According to the invention, the object is achieved by a storage unit for a consumer, comprising an energy storage in which electrical energy can be stored, a current interface via which the storage unit can be connected to an electrical grid, a circuitry which is positioned between the energy storage and the current interface in the direction of current flow, and a server unit which is configured to set up a decentralized computing network along with further server units, via which transactions are managed, controlled and/or monitored in a decentralized manner.

The invention further relates to a storage system having at least two storage units of the aforementioned type which form a decentralized computing network via their server units.

The basic idea of the invention is to set up a decentralized computing network by means of the storage unit(s) provided in a decentralized manner at the user or the consumer in addition to the decentralized storage of electrical energy, the decentralized computing network managing, monitoring and checking itself and the transactions carried out by the computing network such that a superordinate centralized management for the transactions which are performed by means of the server units integrated in the storage units can be at least partially dispensed with. The tasks to be performed by the superordinate management are reduced, optimized or outsourced. The superordinate centralized management can thus at least be configured smaller, which reduces the costs. As the storage unit comprises the energy storage and the server unit which both require cooling units, for example, synergy effects are generated as the cooling unit can be used simultaneously by the energy storage and the server unit. Usually, the decentralized computing network permits a decentralized determination or execution of transactions. The server unit or the computing network can generally be used to provide server performance for a computing service provider, i.e. for a third party with respect to the energy supplier or grid operator. The transactions may in particular involve billings concerning the amounts of energy running through the storage units, i.e. consumption values or feed values, which is usually performed centrally via the energy supplier or the grid operator.

The decentralized management, control and monitoring is also referred to as “Distributed Ledger”.

The server units which set up a decentralized computing network via which the transactions are managed, controlled and/or monitored in a decentralized manner may also be used to provide a so-called “Smart Contract”. The “Smart Contract” is an electronic, self-executing agreement or contract according to the “if then”-principle. This means that a first condition has to be fulfilled for a second condition to be executed. The first condition may be the provision of the electrical energy which is then remunerated accordingly (second condition), if the electrical energy has been provided in the desired manner and as agreed. A human intervention therefor is no longer necessary, as a result of which the regulation expenditure is accordingly reduced.

The electrical grid is for example a domestic electrical grid which is connected to a supply grid operated centrally by an energy supplier or a grid operator. The storage unit is thus included in the domestic electrical grid which provides access to the supply grid. The storage unit can thus, among others, take energy from the supply grid and store it temporarily or deliver temporarily stored energy to the electrical grid. The load on the supply grid can thus be relieved.

The stability of the supply grid can thus be ensured by means of the storage unit. This is additionally due to the fact that the storage unit may be part of a cluster store formed by the storage system which comprises a plurality of storage units. Theses multiple storage units form a large virtual store.

The storage unit is a device installed on the premises of the user or the consumer, i.e. in a private household or in a (small or medium-sized) enterprise, for example.

The storage unit is configured to take energy from the electrical grid and feed the temporarily stored energy into the electrical grid.

According to one aspect, the server unit has a data store which is configured to store data blocks of a blockchain. The entire blockchain can in particular be stored in the data store. The blockchain is a distributed database the integrity of which is secured. This is due to the fact that the cryptographic checksum of the previous data record is secured in the respective subsequent data record. It is thus ensured that the data can no longer be manipulated subsequently or that the data is stored in the correct chronological order. Generally, the blockchain is composed of a series of individual data blocks or data records, in which one or more transactions are respectively combined and provided with a checksum.

Generally, the server unit can include a data store which is configured to store data of a distributed ledgers, i.e. of a shared accounting system.

The transactions are for example data of a third computing service provider that only uses the available server performance of the server unit. They can however also involve data for the billing of the amounts of energy which is otherwise managed, controlled and/or monitored centrally by the energy supplier and/or the grid operator. The computing network formed via the server unit(s) thus provides a blockchain community.

The server unit can include a computing processor, in particular the computing processor being configured to generate data blocks of the blockchain or data of the distributed ledger. Accordingly, the server unit itself is configured so as to create new data blocks, which is also referred to as “mining”. The server unit can therefore also be referred to as a mining unit or as a miner for short. The server unit can transmit the newly generated data block or data record to the further server units of the storage units of the decentralized computing network. The new data block or data set is thus accordingly distributed by the generating server unit in the decentralized computing network. The blockchain which comprises all data blocks is then redundantly stored on all storage units of the storage network, in particular the data stores thereof, provided that the storage units are part of the decentralized computer network. This minimizes the risk of a loss or manipulation of data, in particular the feed and/or consumption data, as this data is not stored centrally.

In addition to the storage units including the server units, further devices can participate in the decentralized computing network which however cannot temporarily store electrical energy, i.e. have no energy storage.

The server unit is in particular a nodal point in the decentralized computing network. The server units of the storage units which form the individual nodal points of the decentralized computing network thus ensure that appropriate data records can be exchanged therebetween, by means of which the entire decentralized computing network is controlled, managed and monitored. The data is for example provided or required by a third computing service provider that uses the server performance provided by the storage unit via the server unit. Accordingly, with regard to the content of the data, the computing service provider may be entirely independent of the storage unit(s), in particular the energy values. However, it may be provided that the data involves consumption or feed data of the individual storage units.

Generally, the storage unit thus provides at the same time a decentralized server performance in addition to the decentralized energy storage. The computing service provider may be a blockchain service provider, which is why the server unit may also be referred to as a mining unit or as a miner.

One aspect provides that the storage unit has a control interface for controlling the energy storage, the energy storage being controllable merely via the control interface which only communicates with an external control means. The energy storage of the storage unit communicates only with the external control means and is controllable only via this control means, as a result of which it is ensured that neither the consumer nor an unauthorized person has access to the control of the energy storage. The external control means can be provided at the place of an energy supplier or of a grid operator of a supply grid connected to the electrical grid. The energy supplier or the grid operator has access to the at least one decentralized storage unit, in particular to the energy storage thereof via the control interface so as to be adapted to control the energy storage from the outside. It is thus possible that the energy supplier or the grid operator decides whether energy from the supply grid is temporarily stored in the energy storage or whether temporarily stored energy from the energy storage is to be consumed by the corresponding consumer, i.e. has to be fed into the electrical grid of the consumer (domestic electrical grid), thus relieving the load on the supply grid. The energy supplier or the grid operator thus operates the cluster store which is formed by the storage system comprising the multiple storage units.

Furthermore, it can optionally be provided that the stored energy from the storage unit is fed into the supply grid such that the fed energy is available to further consumers or users connected to the supply grid.

Preferably, the temporarily stored energy is however only used in the electrical grid of the consumer so as to minimize reference loads in that the electrical grid is provided with energy by the storage unit as needed, as a result of which the load on the supply grid is relieved. The supply grid then does not have to provide energy for the consumer having the storage unit.

A further aspect provides that the storage unit is configured such that exclusively the grid operator, the energy supplier and/or a commissioned service provider has/have access to the storage unit and the energy temporarily stored from the supply grid via the control interface. The control of the access to the cluster store can also be transferred from the energy supplier or the grid operator to an external control service provider. This control service provider then controls the cluster store in accordance with the specifications of its client, i.e. the specifications of the energy supplier or the grid operator.

The energy supplier may be at the same time the grid operator operating and maintaining the supply grid. This is however not necessarily the case. Irrespective of who operates the network, the control of the cluster store can be taken over by a control service provider driving the cluster store in accordance with the specifications of the “owner”.

Alternatively, the grid operator and the energy supplier can simultaneously have access to the storage unit. It can then be provided that the grid operator and the energy supplier can drive different areas. To exclude contrary driving operations, it may be provided that the grid operator assigns access rights to the energy supplier or vice versa. As a rule, only one of them will however have access to the storage unit, in particular to the energy storage thereof.

According to a further alternative or additionally, the external control means may be provided at the place of a selected control service provider taking over the control for the energy supplier and/or the grid operator.

In the following, for better readability, reference is made to the energy supplier or the grid operator. However, the above scenarios show that other constellations are possible.

If excess capacities are present in the supply grid or in the electrical grid, the storage unit can be driven by the external control means so as to temporarily store electrical energy. If the available electrical energy in the electrical grid is not sufficient to cover the energy demand, the control means can control the storage unit, in particular the energy storage thereof such that it feeds the temporarily stored electrical energy into the electrical grid. This (indirectly) reduces the load on the supply grid.

Since only the grid operator or the energy supplier has access to the storage unit, the storage unit can be used in a reliable manner to temporarily store energy that the grid operator or the energy supplier can retrieve when needed. Accordingly, the grid operator or the energy supplier has a reliable energy storage at its disposal, which only the grid operator or the energy supplier can use. The storage unit or the controller is in particular not designed so as to automatically feed temporarily stored energy into the supply grid or temporarily store it from the supply grid.

In general, the temporarily stored electricity in the storage unit can be so-called grey electricity, which was previously fed into the supply grid by the energy supplier. The electrical energy storaged in the at least one storage unit is only temporarily stored from the supply grid via the electrical grid and is not directly available to the consumer. This means that the consumer cannot dispose of the temporarily stored energy itself. Accordingly, the electricity temporarily stored in the storage unit (grey electricity) does not necessarily have to be self-generated electricity (green electricity), which is generated, for example, by a photovoltaic system and temporarily stored by the consumer.

In particular, the server unit is a switchable, flexible load. In this respect, the energy supplier or grid operator having access to the storage unit, in particular to the energy storage, can determine when the server unit is active or inactive. If the frequency in the supply grid is high, the energy supplier or grid operator can switch on the server unit to reduce peaks. The server unit can be switched off in a similar way if the needs in the electrical grid can no longer be covered. The amount of energy (additionally) consumed by the server unit can be sensed by the energy supplier, the grid operator or the server unit itself, so that it is invoiced according to the computing service provider.

According to one embodiment, the storage unit has an energy interface via which the storage unit is connected to an energy generating source, in particular a photovoltaic system. Accordingly, the user or consumer of the storage unit can act as a so-called “prosumer” generating energy itself and feeding it into the supply grid so that it is available to the other participants of the storage system. The electricity that is then fed into the supply grid is accordingly so-called green electricity. In particular, it is provided that the energy generated by the photovoltaic system will be exclusively available to the grid operator or the energy supplier. Accordingly, the consumer or user cannot decide for itself what proportion it feeds into the supply grid or consumes itself.

The storage unit is in particular a “plug-and-play” device that is put into operation by plugging it into a socket. Accordingly, the storage unit is easily connected via a socket connected to the electrical grid, which fully configures the storage unit. The storage unit can be easily connected by the consumer or the user itself. A technician, as needed to install storage units which work with photovoltaic systems, is usually not required here (except in cases where there is no socket at the installation site and an electrician must install and connect a socket there).

The energy storage can have a storage capacity between 1 kWh and 10 kWh, preferably of 2 kWh. Furthermore, the energy storage may be a lead, lead-gel, lithium ion, LiFEPO, lipo, NiCd, NiFe or NiMH accumulator. The small storage capacity of the energy storage ensures that the storage unit is a device that can be used by a consumer or user on site. It also results therefrom that a storage unit can only cover a fraction of the typically existing daily requirements of a private household.

According to one aspect, the circuitry comprises an inverter and a rectifier, the rectifier converting current received via the current interface into direct current for the energy storage and/or the inverter converting current to be fed into the electrical grid via the current interface into alternating current. The design of the circuitry ensures that the storage unit can store electricity from the electrical grid and, if required, can feed stored electrical energy into the electrical grid or supply grid.

A further aspect provides that the control interface is a wireless interface or a wired interface that is also designed for data transmission. The control interface can in particular be a WLAN, Z-Wave, ZigBee, Enocean, Bluetooth, radio, LAN, Ethernet, Powerline, coaxial or glass fiber interface. The design of the control interface as a wireless interface also ensures that the storage unit can be installed at the consumer in a place where there is no other cable connection other than the power connection.

In particular, the server unit uses the control interface to form the decentralized computing network. Accordingly, the decentralized computing network is formed via the connectivity of the control interface. It is thus taken advantage of the fact that the control interface provided for the exclusive driving of the energy storage can at the same time be used to set up a decentralized computing network. However, the driving of the energy storage and the decentralized computing network are independent of each other, so that unauthorized access to the energy storage of the storage unit is prevented.

The server unit integrated in the storage unit, which can also be referred to as a mining unit or as a miner is therefore always supplied with current, sufficiently cooled and furthermore accessible via a network, in particular the Internet.

However, the server unit integrated in the storage unit is a unit that is completely independent of the energy storage or a self-contained unit which uses only common components with the energy storage, such as a cooling unit, the power supply and connectivity, particularly that of the control interface.

A further aspect provides that further devices can be connected to the storage unit. To this end, the storage unit in particular includes further communication interfaces. The further devices may be multimedia devices and/or household appliances, for example, which can (also) be connected to the storage unit via the control interface. However, the further devices cannot drive the storage unit, in particular the energy storage of the storage unit. This variant embodiment is particularly important if the control interface is a wireless interface by means of which several devices can be connected simultaneously. The further optional communication interfaces can be USB, LAN, Ethernet, HDMI or NFC interfaces, for example. In general, the storage unit can be configured as a central communication unit at the consumer or user, in particular in a private household, via which all multimedia devices and/or household appliances communicate. Among other things, the devices connected to the storage unit can transmit consumption values to the storage unit which are read out directly by the energy supplier. To this end, the storage unit can form a bus system, among other things.

Preferably, the storage unit includes a modem and/or a router such that the storage unit can be easily integrated into a network of the consumer or can be used by the user to set up his home network. Accordingly, the modem and/or router include(s) at least the control interface and/or one of the communication interfaces.

The data received from the further devices can be transmitted to the energy supplier, the grid operator and/or the control service provider via the control interface which is also configured for data transmission. The data may include, among others, usage data from further devices located in the WLAN of the user having connected the storage unit.

The storage unit is in particular part of a superordinate storage system. The storage system ensures that fluctuations in the supply grid can be compensated as a single storage unit has a relatively small storage capacity which would not be sufficient to compensate for the fluctuations typically occurring in the supply grid or to provide sufficient energy in case of need. A plurality of storage units makes it possible to form the cluster store, i.e. a large virtual store, which in reality is formed by the many small storage units. This also enables the energy supplier or grid operator to react quickly and precisely, as it can drive individual small storage units.

In particular, a central external control means is provided in the storage system, in particular only the control means having access to the storage units via the control interfaces. As already explained, the control means can be provided at an energy supplier or a grid operator of the supply grid able to drive all storage units which belong to its catchment area. It is thus possible for the grid operator to monitor the supply grid and balance fluctuations in the supply grid accordingly by covering the energy needs of the individual consumers via the storage units located at the consumers.

Alternatively, this can also be done by a control service provider or the energy supplier, to which the grid operator gives appropriate access to the supply area. Capacity peaks in the supply grid can thus be easily buffered via the plurality of storage units.

It is in particular provided that the storage system comprises a plurality of storage units which are simultaneously driven by the control means. It is thus possible to form a large virtual store which is also referred to as cluster store as it comprises several real storage units. The individual storage units can be driven in order to balance fluctuations in the supply grid and thus ensure the stability of the supply grid.

This ensures a stable supply grid, as the energy supplier can rely on the storage units providing the capacities intended by the energy supplier, if so desired. The many storage units which are arranged in a decentralized manner and each have a relatively small storage capacity, form a large virtual store that can only be monitored and controlled by the energy supplier, the grid operator or an assigned control service provider. In particular, this contributes to stabilizing the supply grid, as the many small decentralized storage units can be provided everywhere.

The energy demand of the individual households or consumers is thus covered by the storage units provided there, which relieves the supply grid. A feeding back into the supply grid is not provided here. In this respect, an indirect stabilization or relief of the supply grid is involved.

According to a specific embodiment, it can be provided that the storage units feed electricity into the supply grid. This permits the realization of a direct stabilization of the supply grid. Figuratively speaking, the energy of a storage unit can be transferred via the supply grid to another consumer or household the energy demand of which is higher than the energy temporarily stored by it or which has no storage unit at all.

The storage unit can be configured such that only the grid operator, the energy supplier and/or a commissioned control service provider has/have access to the storage unit and the temporarily stored energy from the supply grid via the control interface. The grid operator, the energy supplier and/or a commissioned control service provider can thus control the amount of energy storaged in the storage unit by driving the storage unit such that energy is temporarily stored in the storage unit or is delivered to the electrical grid to which the storage unit is connected.

The consumer or user itself has no influence on the amount of temporarily stored energy or whether the temporarily stored energy is made available, as is usually the case in decentralized storage units that are operated with or coupled to a photovoltaic system. Remote access by the consumer via mobile phone, Internet or an application on the smartphone does not permit the client to access the storage unit or the energy storaged in the storage unit, either.

If there are excess capacities in the supply grid or in the electrical grid, the storage unit of the storage system can be driven via the control interface such that the storage unit temporarily stores electrical energy. If energy from the storage units is fed into the electrical grid, this is done on the consumer or user side of the electricity meter. The feeding into the overall network thus has the effect of reducing the load.

The storage unit can be a mobile unit that allows the energy supplier to react quickly to changing situations in the supply market. This concerns on the one hand the fluctuations of the supply grid and on the other hand the electricity price. If necessary, the storage unit can therefore be charged and discharged with energy several times during the course of the day.

Since the access to the storage unit, in particular the control thereof, is limited for the consumer, the storage unit preferably remains the property of the energy supplier or the grid operator operating the supply grid, even if the storage unit is provided at the consumer. Alternatively, the storage unit can also be owned by a different energy supplier. A storage unit can for example be offered by an energy supplier A, although the energy supplier B supplies the consumer with energy and uses the supply grid of the grid operator C to do so. The storage unit may also be owned by the grid operator C, although the energy supplier B supplies energy to the consumer.

The storage unit can for example be offered to the consumer free of charge or in connection with a modern communication service, so that a central bus system can be set up without additional costs. Due to the cluster store, the energy supplier has the advantage to be able to actively participate in the electricity market and buy energy in a cost-effective manner and store it temporarily, wherein this energy can later be sold at a high price. The grid operator, on the other hand, is interested in the cluster store, as due to the storage units integrated into the grid, it is able, among other things, to hold instantaneous reserves, it obtains possibilities to maintain voltage and frequency, and the re-establishing of the supply is simplified.

According to one aspect, the storage unit buffers fluctuations in a supply grid to which the electrical grid is connected. The storage unit can therefore be regarded as an energy buffer for the supply grid which is driven by the energy supplier or the grid operator, so that the storage unit contributes to the stable operation of the supply grid or the grid operator can operate the supply grid in a stable manner. Since only the energy supplier or the grid operator has access to the storage unit, a reliable control is also ensured, via which the supply grid can be permanently and reliably operated in a stable manner. If the consumers themselves had access to the storage units, this would not be the case, as then there might no longer be any electrical energy available that could be fed into the electrical grid to indirectly relieve the supply grid.

In particular, the storage unit connected to the electrical grid reduces the load on the supply grid by delivering energy to the electrical grid that is consumed by the consumer of the electrical grid. Therefore, an indirect relief of the supply grid is involved, as the energy is not fed back into the supply grid. The energy temporarily stored at the consumer is used there, as a result of which the supply grid is relieved, since no energy has to be supplied from the supply grid to the electrical grid connected to the supply grid. The storage unit supplies the corresponding electrical grid at least for a short time.

The storage unit is preferably operated exclusively by the grid operator, the energy supplier and/or a commissioned control service provider, so that only the grid operator, the energy supplier and/or a commissioned control service provider has/have access to the storage unit and the energy temporarily stored in the storage unit from the supply grid via the control interface. The consumer where the storage unit is located therefore has no possibility of operating the storage unit itself. The storage unit is exclusively operated externally or driven externally.

According to a further aspect, the storage system simultaneously comprises the decentralized computing network and a central control carried out via the control means. The computing network and the control are configured independently of each other, since the computing network is operated by a computing service provider, whereas the control is carried out via the energy supplier and/or the grid operator.

However, the energy supplier or grid operator can commission a computing service provider, for example, to bill the energy quantities via the decentralized computing network or to do this itself. In general, the energy supplier or grid operator can commission a control service provider to control the energy storage of the storage units.

The computing service provider and the control service provider can generally be the same service provider.

Further advantages and characteristics of the invention will result from the description and the drawings below, to which reference is made and which show:

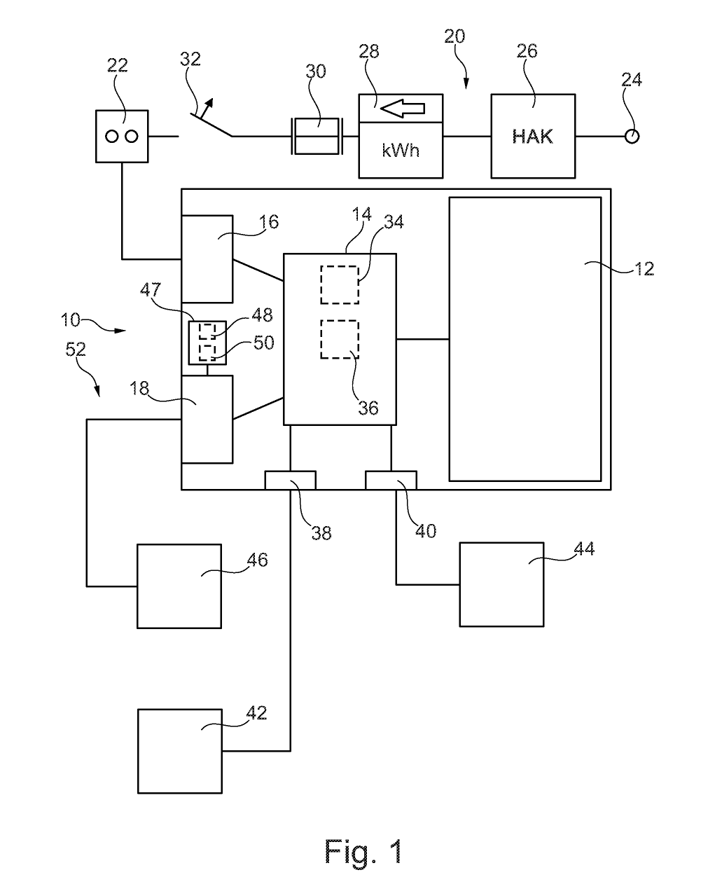

FIG. 1 a schematic representation of a storage unit according to the invention in a first embodiment,

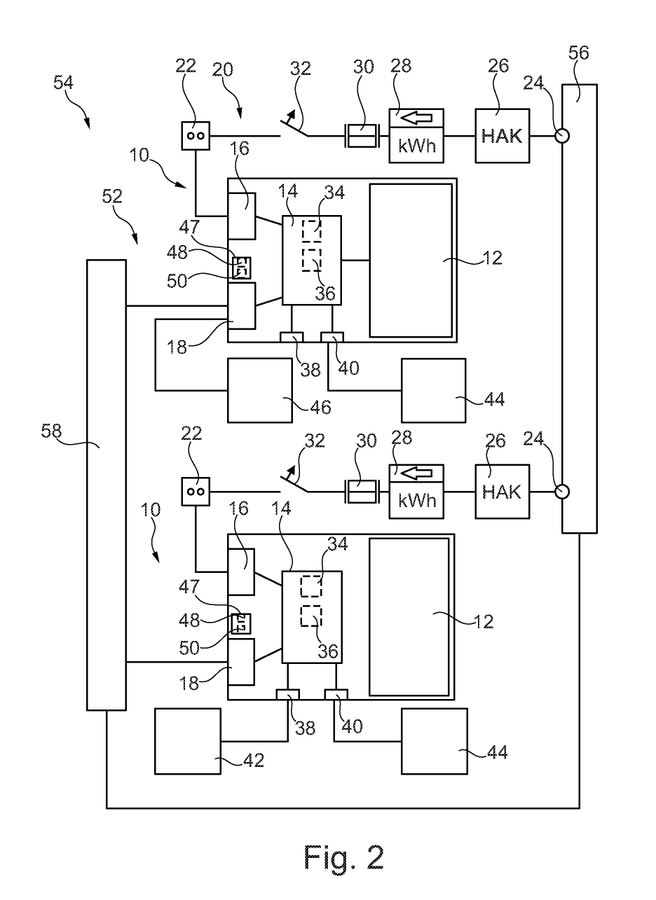

FIG. 2 a schematic representation of a storage system according to the invention, and

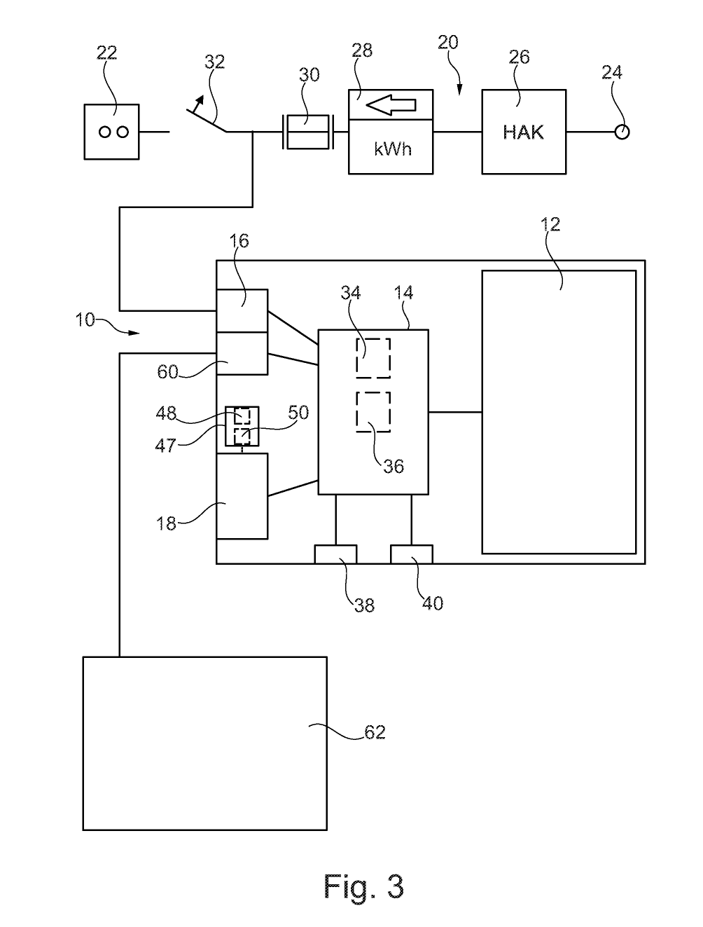

FIG. 3 a schematic representation of a storage unit according to the invention in a second embodiment.

FIG. 1 shows a storage unit 10 for a consumer or a user, respectively, including an energy storage 12, a circuitry 14, a current interface 16 and a control interface 18 which is generally also designed for data transmission. In the example embodiment shown, the consumer is a private household.

The storage unit 10 is connected to a home electrical grid 20 via the current interface 16 in that in the embodiment shown, the current interface 16 is electrically coupled to a domestic socket 22. The storage unit 10 can thus be a so-called “plug-and-play” device which is simply plugged into the domestic socket 22 to be put into operation. The storage unit 10 is pre-configured accordingly.

The home electrical grid 20 is connected to a supply grid not represented here via a connection 24. The connection 24 can be provided on a house connection box (HAK) 26. Generally, the home electrical grid 20 includes, among others, an electricity meter 28, a NZ resistance 30 and a residual-current circuit breaker 32 between the connection 24 and the domestic socket 22.

The storage unit 10 can temporarily store energy from the supply grid via the home electrical grid 20, the circuitry 14 comprising to this end a rectifier 34 which converts the alternating current provided in the home electrical grid 20 into a direct current such that the electrical energy is supplied to the energy storage 12 and can be stored there.

As the storage unit 10 is only provided to temporarily store the electrical energy from the home electrical grid 20 or from the supply grid supplying the home electrical grid 20, the storage unit 10 can supply the temporarily stored electrical energy from the energy storage 12 into the home electrical grid 20. To this end, the circuitry 14 includes an inverter 36 which converts the direct current originating from the energy storage 12 into alternating current such that the electrical energy can be fed into the home electrical grid 20.

The rectifier 34 and the inverter 36 are represented in a dashed line as they are integral components of the circuitry 14.

The control of the storage unit 10, in particular of the energy storaged in the energy storage 12 is generally performed only via the control interface 18 which communicates with an external control means as will be explained below. The control means can be located at an energy supplier, a grid operator or a control service provider commissioned by the energy supplier or the grid operator.

Via the control interface 18, the storage unit 10 receives the control signals at what time the storage unit 10 has to feed energy from the energy storage 12 into the home electrical grid 20 or temporarily store energy from the home electrical grid 20 in the energy storage 12. The energy storage 12 of the storage unit 10 is therefore driven via the control interface 18.

The energy storage 12 can be a small to medium-sized energy storage having a storage capacity between 1 kWh and 10 kWh, preferably of 2 kWh. This corresponds only to a fraction of the typical daily requirement of a private household. The energy storage 12 can be configured as a lead, lead-gel, lithium ion, LiFEPO, lipo, NiCd, NiFe or NiMH accumulator.

In the embodiment shown, the storage unit 10 has two communication interfaces 38, 40 via which further devices 42, 44 are connected to the storage unit 10, which may include multimedia and/or household appliances. The further communication interfaces 38, 40 can be wired or wireless communication interfaces, for example a USB, WLAN or LAN interface. Alternatively, they can be Z-Wave, ZigBee, Enocean, Bluetooth, wireless, Ethernet, powerline, coaxial or glass fiber interfaces.

A further device 46 which may also be a multimedia and/or household appliance is coupled with the control interface 18 which is configured for data transmission or simultaneously as a communication interface, as already explained at the beginning. This further device 46 however does not serve to control the storage unit 10, even if it is connected to the control interface 18, as will be explained below. The further device 46 merely uses the connectivity of this control interface 18.

The further devices 42 to 46 each may be a multimedia device such as a TV set, a computer, a notebook, a tablet or a mobile phone. Furthermore, household appliances which are able to communicate can be connected to the storage unit 10 via the appropriate interfaces 18, 38, 40. Household appliances which are able to communicate may be washing machines, tumble driers, coffee machines, refrigerators, dishwashers, ovens, etc. The further devices 42 to 46 can transmit information to the central storage unit 10 in the household, energy consumption data being for example involved. This data can be transmitted via the control interface 18.

The owner of the private household can control the further devices 42 to 46 via the storage unit 10. There is however no access to the energy storage 12 and the stored energy for the owner of the private household.

The storage unit 10 in particular comprises a modem and/or a router having at least the control interface 18 and/or one of the communication interfaces 38, 40. The user can also install its home network (WLAN) using this router.

The storage unit 10 generally also comprises a server unit 47 which includes a computing processor 48 such as a microcomputer or any other arithmetic unit, and a data store 50. Both the computing processor 48 and the data store 50 are an integral part of the server unit 47 which is connected to the control interface 18.

The server unit 47 communicates with further server units 47 of other storage units 19 and further devices to form a decentralized computing network 52, the decentralized computing network 52 being adapted to monitor, manage and control itself. This will be explained below with reference to FIG. 2.

It is generally possible that to this end, the server unit 47, analogously to the device 46, uses the connectivity of the control interface 18 via which the server unit 47 is for example permanently connected to the Internet.

FIG. 2 shows a decentralized storage system 54 having in the embodiment shown two storage units 10 which are configured in accordance with the embodiment shown in FIG. 1. Generally, the storage system 54 can comprise further storage units 10.

The storage units 10 are each integrated into a separate home electrical grid 20, the two home electrical grids 20 being connected to a common supply grid 56 via their respective connections 24. Both home electrical grids 20 are thus supplied by the supply grid 56.

Furthermore, the decentralized storage system 54 includes a common central control means 58 which is coupled with the storage units 10 via their respective control interfaces 18, to access, among other things, the energy storaged in the energy storages 12 of the storage units 10 or charge the energy storage 12, respectively.

Metaphorically speaking, FIG. 2 shows two separate private households, for example two detached family houses in a housing estate having their own home electrical grid 20 each connected to the common supply grid 56 of the grid operator which includes the central control means 58. Both private households can furthermore be supplied with energy by a common energy supplier.

The central control means 58 is also coupled to the supply grid 56, to monitor, among other things, the supply grid 56, in particular to determine excess capacities or fluctuations.

Therefore, the control means 58 for example determines whether capacities peaks that are to be buffered are present in the supply grid 56. Furthermore, the central control means 58 determines whether the energy demand exceeds the energy available in the supply grid 56 or in the corresponding home electrical grid 20. The central control means 58 then drives the storage units 10 provided in the storage system 54 such that the fluctuations in the supply grid 56 are balanced.

The entire energy demand can be determined via the supply grid 56 itself in that the mains frequency in the supply grid 56 is for example monitored, which gives information about the mains demand.

The central control means 58 then detects whether the total energy demand is higher than the available electrical energy. If this is the case, the central control means 58 drives the individual storage units 10 such that electrical energy temporarily stored in the respective energy storages 12 is fed into the home electrical grid 20 associated with the storage unit 10 to cover the energy demand. The supply grid 56 is thus indirectly relieved as the required energy is supplied to the home electrical grid 20 of the consumer or user through the feeding of the temporarily stored energy from the storage unit 10. The temporarily stored energy is energy previously obtained from the supply grid 56, i.e. so-called grey electricity.

In case the central control means 58 determines that the energy demand is lower than the electrical energy available in the supply grid 56, it can drive the storage units 10 such that the excess electrical energy from the supply grid 56 is temporarily stored in the respective energy storages 12 of the storage units 10 via the home electrical grids 20.

A feeding into the home electrical grid 20 is also possible if the energy supplier can acquire energy in an inexpensive way and temporarily stores it in the storage unit 10, in particular in the energy storage 12, for a later consumption.

The storage of electrical energy in the storage units 10 and the discharge of the storage units 10 can thus be performed irrespective of the mains situation.

The control of the respective storage units 10 thus takes place only and exclusively via the central control means 58. The owner of the private households cannot drive the storage units 10 so as to have access to the energy storage 12. It is merely possible to drive the further devices 42 to 46 which are connected to the communication interfaces 38, 40 and the control interface 18.

The energy storage 12 is controllable only via the control interface 18, exclusively the grid operator or the energy supplier having access to the energy storage 12 via the control interface 18, even if further devices should use the connectivity of the control interface 18.

Via the control interface 18 configured for data transmission, it is for example also possible to provide further data, in particular usage data of the connected devices 42 to 46 which are transmitted to the central control means 58 such that the energy supplier or the grid operator or an appropriately authorized service provider has/have access to this data.

According to one variant embodiment, it is provided that no feeding-back into the supply grid 56 is possible. The energy temporarily stored in the storage unit(s) 10 is thus exclusively made available to the home electrical grid 20, as a result of which reference loads of the supply grid 56 are indirectly balanced.

Generally, the energy temporarily stored in the storage unit(s) 10 is energy provided by the energy supplier and forwarded to the consumer by the grid operator, i.e. so-called grey electricity. The energy temporarily stored in the storage unit(s) 10 is thus not self-generated energy (green electricity), as is the case in a connected photovoltaic system.

The installation of the storage unit 10 is simple as the consumer or user simply plugs the storage unit 10 into the socket 22 in its home electrical grid 20. A technician for the installation of the storage unit 10 is usually not necessary, provided that no new socket 22 has to be installed.

Using the storage system 54, it is thus possible to form a cluster store, as many decentralized storage units 10 are provided in as many private households of the supply grid 56 as possible, to which the energy supplier or grid operator has access.

It can in particular be provided that the storage units 10 communicate with the respective electricity meters 28 which detect the corresponding client-side energy consumption.

In addition to the decentralized storage of electrical energy which can however be retrieved in a centralized manner by the energy supplier, the grid operator or a commissioned control service provider via the central control means 58, the decentralized storage system 54 simultaneously forms a decentralized computing network 52, in particular also via the control interfaces 18 designed for communication. To this end, the storage units 10 include the appropriately configured server units 47.

The server units 47 of the two represented storage units 10 each communicate with each other via their control interface 18 and form the decentralized computing network 52.

Generally, different transactions can be determined or carried out in a decentralized manner via the decentralized computing network 52, this being automatically carried out without any access from the outside in the decentralized computing network 52. The decentralized and for the most part independent management, checking and monitoring of transactions is also referred to as “distributed ledger” technology or as blockchain technology. In this respect, the respective server unit 47 is configured to participate in a “distributed ledger” community or blockchain community, thus to appear as a mining unit or as a miner in the decentralized computing network 52.

To this end, the server unit 47 has the required computing capacity through its computing processor 48. The computing processor 48 is thus able to generate data blocks of the blockchain, i.e. to actively participate in the “mining”.

Furthermore, the server unit 47 can distribute the data block newly generated via the computing processor 48 to the other participants of the blockchain community via the control interface 18. The data blocks, in particular the entire blockchain can further be stored in the data store 50 of the server unit 47.

In this respect, the storage unit 10 is to be considered as a nodal point of the decentralized computing network 52 via its server unit 47, as it is an (active) participant of the “distributed lodger” or blockchain community.

The server unit 47 or the computing network 52 can in general be used to make server performance available to a computing service provider, thus to a third party with respect to the energy supplier or the grid operator, which can also be referred to as a “distributed ledger” or blockchain service provider. Therefore, the transactions carried out via the server units 47 need not be related to the energy storages 12. Rather, the server unit 47 is not influenced by the energy storage 12.

The decentralized computing network 52 therefore constitutes a distributed database in which the data is securely and redundantly stored.

Generally, the miner technology conferred by the server unit 47 of the storage unit 10 can be used by a third computing service provider as the individual server units 47 provide computing power via their computing processor 48 and provide data storage capacity via their data stores 50.

The data processing is performed via the computing network 52 due to so-called blockchains which are composed of a plurality of data blocks or data records in which one or more transactions are respectively combined and provided with a check sum.

The respective computing processor 48 of the server unit 47 therefore calculates a corresponding data block due to a transaction. The server unit 47 of the storage unit 10 is thus itself configured to produce new data blocks. This is also referred to as “mining”. The server unit 47 is thus a mining unit or a miner.

The storage unit 10 distributes the newly generated data block via the control interface 18 to the further storage units 10 of the decentralized computing network 52, in particular the server units 47 thereof, and to other participants of the decentralized computing network 52, which are for example not nodal points as they do not generate any data blocks.

It is also possible that participants of the computing network 52 have no energy storages such that they only participate in the decentralized computing network 52.

The appropriately newly generated data block which is distributed in the decentralized computing network 52 is attached to the existing blockchain such that the updated blockchain is redundantly present on all participants of the decentralized computing network 52, in particular in the respective data stores 50. This minimizes the risks of a data loss or a data manipulation, as this data is present in a decentralized and redundant manner instead of being stored in a central manner.

A check sum of the previous blockchain is furthermore respectively comprised in the newly generated data block, as a result of which the integrity is ensured. A subsequent modification or influence of the blockchain is thus prevented. The correct chronological order is also ensured.

The storage units 10, in particular the server units 47 thereof ensure that appropriate data records or data blocks can be exchanged therebetween, by means of which the control, management and monitoring of the entire decentralized computing network 52 is performed.

To this end, the server units 47 make use of the connectivity required by the storage units 10, by means of which the central control means 58 drives the energy storages 12 of the storage units 10, i.e. the connectivity of the control interface 18.

Therefore, the control means 58 exclusively serves to control the energy amounts temporarily stored in the energy storages 12 of the storage units 10 to operate the supply grid 56 in a stable manner.

The transactions realized via the decentralized computing network 52 may also be billings of the energy amounts, i.e. consumption values or feed values, which is usually carried out centrally via the energy supplier or the grid operator. Accordingly, this can be performed in a decentralized way in a simpler and more cost-effective manner, the data security being simultaneously ensured and even increased as compared with a conventional central data storage.

The data processed by the server units 47 may be all types of data which are to be exchanged in a secured manner between the individual server units and stored in a decentralized database, i.e. also consumption and feed data of the individual storage units 10. Generally, the server units 47 however make only their computing power and data storage capacities available.

The participants of the decentralized computing network 52 are generally configured such that they automatically come to an agreement with regard to transactions to be performed, which is especially why no regulation or access from the outside is required, which corresponds to the blockchain technology.

The server unit 47 can in particular be used by the energy supplier or the grid operator as a switchable, flexible load such that the server unit 47 is switched on if there are excess capacities in the electrical grid 20. The server unit 47 is switched off in an analogous way, if the energy demand exceeds the available energy. In this respect, the server unit 47 can be switched on and off by the energy supplier or grid operator to react to the energy requirements. As a plurality of server units 47 form the decentralized computing network 52, it is ensured that the blockchain community is fully operational, even if individual server units 47 are switched off.

FIG. 3 shows a second embodiment of the server unit 10 which is coupled to an energy generating source 62 of the server unit 10 via an energy interface 60. The energy generating source 62 may for example be a photovoltaic system.

It is therefore possible to temporarily store energy generated in the storage unit 10 itself, which is accordingly made available to the storage system 54. The consumer or user is a so-called “prosumer” as it itself provides energy to the community.

In the embodiment shown, the energy interface 60 is an interface which is configured separately from the current interface 16 and which is also coupled to the circuitry 14. Alternatively, the energy interface 60 and the current interface 16 can also be configured jointly.

Owing to the present energy generating source 62, the storage unit 10 is integrated into the electrical grid 20 between the residual-current circuit breaker 32 and the NZ resistance 30. A technician is therefore necessary to connect this storage unit 10.

The decentralized storage system 54 thus provides a decentralized energy storage to temporarily store electrical energy and retrieve it as required in order to relieve the load on the supply grid 56. This is possible because only the energy supplier or the grid operator has access to the energy storage 12 of the respective storage units 10 via the control interface 18. At the same time, the decentralized storage system 54 forms a decentralized computing network 52, via which blockchains can be generated and processed in a decentralized manner. To this end, the storage units 10 of the decentralized storage system 54 have corresponding server units 47, which actively participate in the blockchain community as mining units.

It is here taken advantage of the fact that the respective storage units 10 are permanently connected to the Internet due to the central driving by the energy supplier or grid operator, which is also a precondition for the blockchain community.

Further synergy effects can additionally be used, such as the sufficient cooling of the energy storage 12 and of the server unit 47.

The storage unit 10 of the storage system 54 thus forms the interface to the energy grid (supply grid 56) and to the communication network (Internet), such that the storage unit 10 can not only store electrical energy, but also simultaneously provides computing power for blockchain applications, for example.

The specific field of application for the blockchain application is left up to the owner or proprietor of the storage unit 10, the server unit 47 being for example adapted to be used as a mining unit for the energy supplier or the grid operator, such that an effective device is produced to make the low-voltage range or the supply grid more flexible and at the same time optimize the occurring transactions, in particular the purchase and distribution of energy amounts.

On the other hand, the server unit 47 acting as a mining unit, in particular the data storage capacity and/or computing power thereof, can be provided for service providers which do not operate on the energy market, for example.

The supply grid 56 remains in any case centrally managed, controlled or monitored due to the central and superordinate control means 58 to ensure the network security and the network stability, whereas the transactions (operative activities) related thereto can however be verified and handled in a decentralized and cost-effective manner.

As the storage units 10 are suitable for storing the smallest amounts of energy and the blockchain technology is at the same time suitable for small unit transactions due to the low transaction costs, synergy effects on the energy market are all in all obtained, which are used by the storage unit 10 and the storage system 56.

1. A storage unit for a consumer, comprising:
an energy storage in which electrical energy can be stored;
a current interface via which the storage unit can be connected to an electrical grid;
a circuitry which is positioned between the energy storage and the current interface in the direction of current flow; and
a server unit which is configured to set up a decentralized computing network along with further server units, via which transactions are managed, controlled and/or monitored in a decentralized manner.

2. The storage unit according to claim 1, wherein the server unit has a data store which is configured to store data blocks of a blockchain.

3. The storage unit according to claim 1, wherein the server unit has a computing processor, in particular the computing processor being configured to generate data blocks of the blockchain.

4. The storage unit according to claim 1, wherein the storage unit is a nodal point in the decentralized computing network.

5. The storage unit according to claim 1, wherein the storage unit has a control interface for controlling the energy storage, the energy storage being controllable only via the control interface which communicates only with an external control means.

6. The storage unit according to claim 1, wherein the storage unit is configured such that exclusively the grid operator, the energy supplier and/or a commissioned service provider has/have access to the storage unit and the energy temporarily stored from the supply grid via the control interface.

7. The storage unit according to claim 1, wherein the server unit is a flexible switchable load.

8. The storage unit according to claim 1, wherein the storage unit has an energy interface via which the storage unit is connected to an energy generating source, in particular a photovoltaic system.

9. The storage unit according to claim 1, wherein the storage unit is a “plug-and-play” device which is put into operation by a connection to a socket.

10. The storage unit according to claim 1, wherein the energy storage has a storage capacity between 1 kWh and 10 kWh, preferably of 2 kWh.

11. A storage system comprising at least two storage units according to any of the preceding claims which form a decentralized computing network via their server units.

12. The storage system according to claim 11, wherein the storage system has a central external control means, in particular exclusively the control means having access to the storage units via the control interfaces.

13. The storage system according to claim 11, wherein the storage system comprises simultaneously a decentralized computing network and a central control which takes place via the control means.
